(19) United States
(12) Patent Application Publication
(10) Pub. No.: US 2026/0281054 A1
(43) Pub. Date: Sep. 17, 2026

(54) Method and Traffic Management Apparatus for Managing Data Flows in a Data Transmission System

(71) Applicant: Airoha Technology Corp., Hsinchu City (TW)

(72) Inventors: Kuo-Cheng Lu, Hsinchu City (TW); Jian-Cheng Chen, Hsinchu County (TW)

(73) Assignee: Airoha Technology Corp., Hsinchu City (TW)

(21) Appl. No.: 19/277,366

(22) Filed: Jul. 22, 2025

Related U.S. Application Data
(60) Provisional application No. 63/770,933, filed on Mar. 12, 2025.

(51) Int. Cl. H04L 47/76; H04L 47/70

(52) U.S. Cl. CPC H04L 47/76; H04L 47/82

(57) ABSTRACT

A method for managing a plurality of data flows associated with a network processing component in a data transmission system includes providing a plurality of traffic control units, each associated with a respective data flow of the plurality of data flows; dynamically adjusting a committed information rate (CIR) for the plurality of traffic control units; and controlling data rates of the plurality of data flows using the plurality of traffic control units with the adjusted CIR.

### CROSS REFERENCE TO RELATED APPLICATIONS

This application claims the benefit of U.S. Provisional Application No. 63/770,933, filed on March 12, 2025. The content of the application is incorporated herein by reference.

### BACKGROUND OF THE INVENTION

### 1. Field of the Invention

The present invention relates to a method and traffic management apparatus for managing data flows in a data transmission system, and more particularly, to a method and traffic management apparatus for managing data flows in a data transmission system to reach max-min or weighted fairness without the complexity of per-flow queuing.

### 2. Description of the Prior Art

In data transmission systems, such as routers, gateways, and other network devices, managing bandwidth allocation among multiple data flows is essential for ensuring fair and efficient utilization of network resources. Traditional approaches to bandwidth management primarily rely on two categories of techniques: metering and queuing/scheduling. However, both categories exhibit significant limitations, particularly in dynamic network environments where traffic loads and available bandwidth vary unpredictably.

Metering mechanisms, such as the two-rate Three Color Meter (trTCM) specified in RFC 2698, are widely used for traffic policing. In trTCM, each meter is associated with a specific data flow and marks packets as green, yellow, or red based on predefined Committed Information Rate (CIR) and Peak Information Rate (PIR) thresholds. Green packets are deemed compliant and guaranteed transmission, while yellow packets may be transmitted under certain conditions, and red packets are typically discarded. A fundamental drawback of the traditional metering techniques is that the CIR and PIR must be manually configured by network administrators. These static settings require prior knowledge of traffic patterns, which is often unavailable or inaccurate in dynamic networks. Consequently, traditional meters cannot adapt to real-time changes in traffic load or available bandwidth. For example, if an egress rate of a bottleneck link fluctuates, a manually set CIR may result in over-allocation or under-allocation of bandwidth, which fails to achieve fair bandwidth sharing, such as max-min fairness, across data flows.

Moreover, traditional metering mechanisms exacerbate unfairness due to the probabilistic discarding behavior of yellow packets. In trTCM, yellow packets are subject to probabilistic discarding when queue depth lies between a minimum and maximum threshold, such as in Random Early Detection (RED) or similar queue management schemes. This randomness introduces variability in bandwidth allocation, as flows sending a higher proportion of yellow packets may, by chance, have more packets transmitted, thereby gaining disproportionate bandwidth compared to other flows with a lower proportion of yellow packets. For instance, if one flow generates more yellow packets than another under similar network conditions, the probabilistic nature of yellow packet transmission can result in that flow receiving an unfairly larger share of the available bandwidth. This behavior undermines the goal of max-min fairness, where each flow should receive an equitable share of bandwidth up to its demand or the system capacity, as the unpredictable transmission of yellow packets disrupts consistent and fair allocation across flows.

To achieve fairness, the prior art often employs per-class or per-flow queuing and scheduling mechanisms, such as Weighted Fair Queuing (WFQ) or Approximate Fair Dropping (AFD). These techniques maintain separate queues for each class or flow and use scheduling algorithms to allocate bandwidth proportionally. However, while effective for fairness, these methods introduce significant complexity and cost, particularly as the number of data flows increases. Each additional queue requires dedicated memory and processing resources, and scheduling computations must be performed in real-time. In large-scale networks with numerous flows, this overhead becomes prohibitive, rendering such solutions impractical for cost-sensitive or resource-constrained environments, thus limiting their applicability in modern networks with a large number of data flows.

Therefore, there is an urgent need in the industry for an efficient, scalable, and adaptive solution for fair bandwidth sharing in dynamic network environments.

### SUMMARY OF THE INVENTION

Therefore, the present invention is to provide a method and traffic management apparatus for managing data flows in a data transmission system, to address the shortcomings of the prior art.

An embodiment of the present invention discloses a method for managing a plurality of data flows associated with a network processing component in a data transmission system. The method comprises providing a plurality of traffic control units, each associated with a respective data flow of the plurality of data flows; dynamically adjusting a committed information rate (CIR) for the plurality of traffic control units; and controlling data rates of the plurality of data flows using the plurality of traffic control units with the adjusted CIR.

Another embodiment of the present invention discloses a traffic management apparatus for managing a plurality of data flows associated with a network processing component in a data transmission system. The traffic management apparatus comprises an adjustment circuit that dynamically adjusts a committed information rate (CIR) for a plurality of traffic control units, wherein each of the plurality of traffic control units is associated with a respective data flow of the plurality of data flows; and a rate control circuit that controls data rates of the plurality of data flows using the plurality of traffic control units with the adjusted CIR.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a data transmission system in accordance with an embodiment of the present invention.

FIG. 2A and FIG. 2B are schematic diagrams of simulation results of a traditional fixed CIR system and the data transmission system shown in FIG. 1 assessing max-min fairness for User Datagram Protocol (UDP) traffic.

FIG. 3A and FIG. 3B are schematic diagrams of simulation results of a traditional fixed CIR system and the data transmission system shown in FIG. 1 assessing max-min fairness for Transmission Control Protocol (TCP) traffic.

FIG. 4A and FIG. 4B are schematic diagrams of simulation results of the data transmission system shown in FIG. 1 assessing weighted fairness for both UDP and TCP traffics.

FIG. 5A and FIG. 5B are schematic diagrams of simulation results of a traditional fixed CIR system and the data transmission system shown in FIG. 1 assessing max-min fairness for UDP traffic.

FIG. 6A and FIG. 6B are schematic diagrams of simulation results of a traditional fixed CIR system and the data transmission system shown in FIG. 1 assessing max-min fairness for TCP traffic.

FIG. 7A and FIG. 7B are schematic diagrams of simulation results of the data transmission system shown in FIG. 1 assessing weighted fairness for both UDP and TCP traffics.

FIG. 8 illustrates a process in accordance with an embodiment of the present invention.

### DETAILED DESCRIPTION

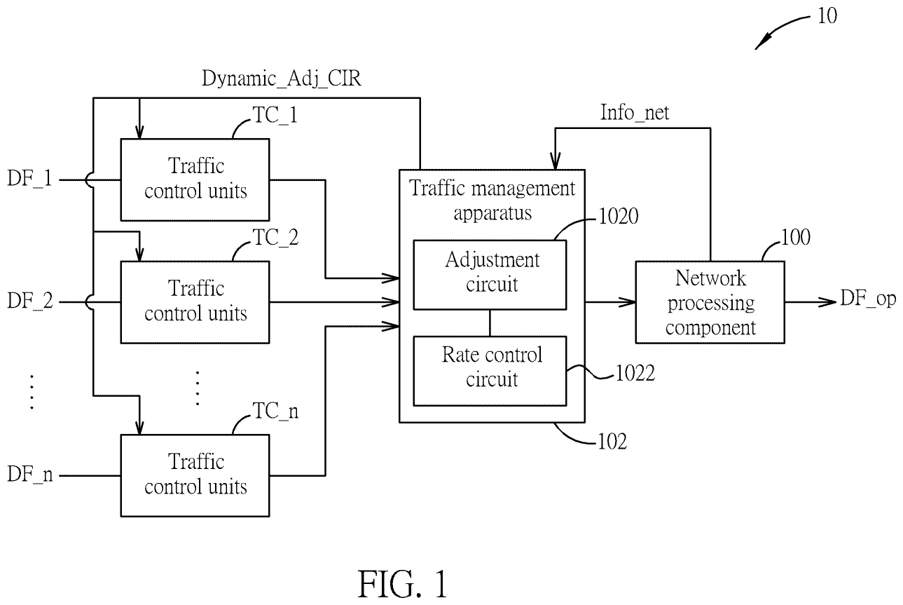

Please refer to FIG. 1, which illustrates a data transmission system 10 for managing a plurality of data flows DF_1 to DF_n in accordance with an embodiment of the present invention. The data transmission system 10 may be implemented in various network devices, such as routers, switches, gateways, or other network nodes, and may operate in environments like local area networks (LANs), wide area networks (WANs), or cloud-based networks. The data transmission system 10 is particularly advantageous in dynamic network environments where traffic loads and available bandwidth vary unpredictably. As shown in FIG. 1, the data transmission system 10 includes a plurality of traffic control units TC_1 to TC_n (e.g., meters), a network processing component 100, and a traffic management apparatus 102, which collectively process the data flows DF_1 to DF_n with an input data rate, to produce an output data flow DF_op with an egress rate.

The data transmission system 10 is configured to dynamically manage data rates of the data flows DF_1 to DF_n to achieve fair bandwidth allocation, such as max-min fairness or weighted fairness, under varying network conditions (e.g., unpredictably varying the input data rate or egress rate). Each data flow DF_i represents a stream of data packets from a source, such as a user equipment, application, or device, traversing the data transmission system 10. Each traffic control unit TC_i (where i ranges from 1 to n) is associated with a respective data flow DF_i and is responsible for controlling its data rate based on a committed information rate (CIR). The traffic control units TC_1 to TC_n mark packets as compliant or non-compliant, and prioritize compliant packets for transmission to the network processing component 100. For example, in two-rate Three Color Meter (trTCM), the compliant packet is marked as green, while a non-compliant packet is marked as yellow or red, which will be described in detail below. The network processing component 100 is a functional or physical entity where the data flows DF_1 to DF_n converge for processing, to produce the output data flow DF_op. In some embodiments, the network processing component 100 is implemented with a queue, a rate-limiting meter or a traffic shaper, or a meter, which will be described in detail below. In other words, the output data flow DF_op is an aggregated stream of packets exiting the network processing component 100, transmitted to downstream network nodes or destinations. The network processing component 100 measures an ingress rate (which is the total data rate of compliant packets from the traffic control units TC_1 to TC_n) and an egress rate (which is the data rate of the output data flow DF_op), and provides network information Info_net, including a queue busy status (indicating a load condition), the ingress rate, and the egress rate, to the traffic management apparatus 102. Alternatively, the ingress rate may also be obtained by the traffic management apparatus 102, for example, by directly monitoring the output rates of the traffic control units TC_1 to TC_n or receiving ingress rate information from the traffic control units TC_1 to TC_n.

The traffic management apparatus 102 coordinates the traffic control units TC_1 to TC_n and receives the network information Info_net from the network processing component 100 to dynamically manage the data flows DF_1 to DF_n. As depicted in FIG. 1, the traffic management apparatus 102 comprises an adjustment circuit 1020 and a rate control circuit 1022, which collaborate to achieve fair and efficient bandwidth allocation. Specifically, the adjustment circuit 1020 dynamically adjusts the CIR for the plurality of traffic control units TC_1 to TC_n based on a difference between the ingress rate of the compliant packets and the egress rate of the output data flow DF_op at the network processing component 100. The adjustment circuit 1020 processes the rate difference between the ingress rate and the egress rate to compute a shared CIR adjustment parameter, referred to as Dynamic_Adj_CIR, which facilitates coordinated CIR updates across all the traffic control units TC_1 to TC_n.

The rate control circuit 1022 controls the data rates of the data flows DF_1 to DF_n by directing the traffic control units TC_1 to TC_n to apply the CIRs adjusted by the adjustment circuit 1020. In some embodiments, the adjustment circuit 1020 performs CIR adjustments periodically at a predetermined time interval, such as every T seconds, to maintain responsiveness to dynamic network conditions. At each interval, the adjustment circuit 1020 processes the latest network information Info_net, re-computes the rate difference, and updates the CIR adjustment parameter Dynamic_Adj_CIR. As a result, the coordinated operation of the adjustment circuit 1020 and the rate control circuit 1022 within the traffic management apparatus 102 ensures that the CIRs of the traffic control units TC_1 to TC_n are dynamically tuned with the aim of balancing the ingress and egress rates, so as to achieve efficient bandwidth utilization and fairness across the data flows DF_1 to DF_n, particularly under load conditions indicated by the queue busy status in the network information Info_net.

In short, the data transmission system 10, through its use of the shared CIR adjustment parameter Dynamic_Adj_CIR, provides a significant advantage over traditional bandwidth management systems by enabling coordinated rate control across all the traffic control units TC_1 to TC_n. This shared parameter, as utilized by the traffic management apparatus 102, allows the data transmission system 10 to dynamically align the ingress rate with the egress rate, ensuring max-min or weighted fairness without the complexity of per-flow queuing. This approach also mitigates the unfairness caused by probabilistic packet discarding in the conventional metering scheme, and enhances scalability for large-scale networks.

It should be noted that the data transmission system 10 shown in FIG. 1 represents the main operational architecture of the embodiment of the present invention. Those skilled in the art may select appropriate components or make appropriate modifications according to various network configurations and operational requirements, so as to leverage the shared CIR adjustment parameter Dynamic_Adj_CIR to achieve diverse fairness objectives.

For example, the ingress rate is preferably defined as the total data rate of compliant packets from the traffic control units TC_1 to TC_n, as this ensures precise control over prioritized green packets, contributing to fairness and efficiency. However, alternative definitions of the ingress rate may be adopted depending on network requirements, such as the total data rate of all packets (including compliant green packets as well as non-compliant yellow and red packets) input to the network processing component 100, or a subset of packets based on specific traffic classes, as long as the adjustment circuit 1020 can compute the rate difference to update the CIR adjustment parameter Dynamic_Adj_CIR effectively.

The network information Info_net is a set of data provided by the network processing component 100 to the traffic management apparatus 102, enabling dynamic management of the data flows DF_1 to DF_n. The specific contents of the network information Info_net are determined by the system design and may be adjusted to suit operational requirements. For example, the network information Info_net typically includes the egress rate (the data rate of the output data flow DF_op) and the queue busy status (indicating congestion or load conditions). If the network processing component 100 is configured to measure the ingress rate (the total data rate of compliant packets from the traffic control units TC_1 to TC_n), the network information Info_net includes this ingress rate, allowing the traffic management apparatus 102 to directly utilize it for CIR adjustments. Alternatively, if the ingress rate is measured or determined independently by the traffic management apparatus 102, such as through monitoring the output of the traffic control units TC_1 to TC_n, the network information Info_net excludes the ingress rate. Additional parameters, such as queue depth or packet loss rates, may also be included in the network information Info_net depending on the capabilities of the network processing component 100, ensuring flexibility in supporting various network configurations.

Moreover, as mentioned in the above, each traffic control unit TC_i marks packets of its respective data flow DF_i as compliant if their data rate is below the CIR, ensuring these packets are prioritized for transmission to the network processing component 100. In an embodiment, each traffic control unit TC_i may employ a two-rate three-color marking (trTCM) mechanism, as specified in RFC 2698, to classify packets as green (compliant), yellow, or red. Green packets, marked when the data rate is less than the CIR, are guaranteed transmission, contributing to the ingress rate, which is the total data rate of compliant packets from the traffic control units TC_1 to TC_n. Yellow and red packets may be discarded or eprioritized based on network conditions, such as a queue busy status in the network information Info_net, ensuring the ingress rate comprises primarily green packets for precise rate control and fairness.

Furthermore, to enhance precision, the adjustment circuit 1020 may incorporate a proportional-integral-derivative (PID) controller to determine the CIR adjustment. In an embodiment, the PID controller processes the rate difference using a proportional term that corresponds to the current difference, with the current difference value scaled by a parameter Kp; an integral term that accumulates differences over time, with the accumulated value scaled by a parameter Ki; and a derivative term that evaluates the rate of change, with the evaluated value scaled by a parameter Kd. The PID controller may also include a constant value α to guide CIR changes when the ingress rate equals the egress rate, ensuring stability. The PID controller updates the CIR adjustment parameter Dynamic_Adj_CIR, which the adjustment circuit 1020 uses to adjust the CIRs of the traffic control units TC_1 to TC_n. The algorithm performed by the PID controller may be concluded as follows:
for every T seconds:

r_diff=e_rate−i_rate

intl+=r_diff

Dynamic_Adj_CIR+=(Kp*r_diff+Ki*intl+Kd*(r_diff−old_r_diff)+α)
old_r_diff=r_diff
   where:
r_diff represents the rate difference, defined as the egress rate (the data rate of the output data flow DF_op) minus the ingress rate (total data rate of packets marked as compliant (green) by the traffic control units TC_1 to TC_n);
e_rate represents the egress rate, which is the data rate of the output data flow DF_op exiting the network processing component 100, reported in the network information Info_net;
i_rate represents the ingress rate, which is the total data rate of compliant (green) packets input to the network processing component 100 from the traffic control units TC_1 to TC_n; intl represents the integral term, which is the accumulated sum of rate differences over time, updated iteratively;
Kp represents the proportional coefficient, a scaling factor for the proportional term in the PID controller;
Ki represents the integral coefficient, a scaling factor for the integral term in the PID controller;
Kd represents the derivative coefficient, a scaling factor for the derivative term in the PID controller;
old_r_diff represents the rate difference from the previous iteration, used to compute the rate of change;

Dynamic_Adj_CIR represents the shared CIR adjustment parameter, updated by the PID controller to reflect the required CIR adjustment; and
α represents the constant, a value that influences the direction of CIR changes when the ingress rate equals the egress rate. The value of α is predefined to enable a reduction in CIR in application scenarios where mechanisms automatically reduce the ingress rate, such as TCP's congestion control, which lowers the ingress rate in response to a reduced egress rate. This ensures that the CIR is appropriately decreased to maintain fairness across data flows, preventing the CIR from remaining constant or increasing, which could otherwise lead to unfair bandwidth allocation. Without α, the CIR may fail to decrease, thereby hindering the achievement of fairness.

The above PID algorithm provides a robust framework for CIR adjustment but can be flexibly modified to suit specific network requirements. For example, certain terms, such as the integral term (intl) or the constant α, may be omitted to simplify computations, or additional terms, such as queue depth or traffic priority factors, may be incorporated to enhance control precision. These modifications maintain the core functionality of dynamically updating the CIR adjustment parameter Dynamic_Adj_CIR based on rate differences, enabling the traffic management apparatus 102 to adapt to diverse operational scenarios, as described in the following embodiments.

For example, in an embodiment, the network processing component 100 is a queue with a buffer. The adjustment circuit 1020 may further monitor the queue depth, included in the network information Info_net. For example, if the queue depth exceeds a reference queue depth, indicating congestion (e.g., a queue busy status), the adjustment circuit 1020 further adjusts the CIRs based on the difference between the reference queue depth and the current queue depth. In such a situation, when the adjustment circuit 1020 incorporates the PID controller to determine the CIR adjustment, the algorithm of the PID controller may further incorporate the queue depth term. For example, the algorithm performed by the PID controller may be replaced as follows:
for every T seconds:

r_diff=e_rate−i_rate

intl+=r_diff
if cur_queue_depth<ref_queue_depth:

Kq=0

Dynamic_Adj_CIR+=(Kp*r_diff+Ki*intl+Kd*(r_diff−old_r_diff)+Kq*(ref_queue_depth−cur_queue_depth)+α)
old_r_diff=r_diff
   where:
cur_queue_depth represents the current queue depth, which is the number of packets currently stored in the buffer of the network processing component 100;
ref_queue_depth represents the reference queue depth, a predetermined target value for the queue depth; and
Kq represents the queue depth adjustment coefficient, a scaling factor applied to the queue depth difference, set to zero when there is no need to consider queue depth as a factor for adjusting the CIR adjustment parameter Dynamic_Adj_CIR. For example, setting Kq to zero may be applied in network scenarios where queue congestion is not a concern, such as when the output bandwidth is sufficiently large, or when managing buffer bloat is not a priority. Conversely, setting Kq to a non-zero value indicates that the CIR adjustment should account for the queue state, enabling dynamic CIR adjustments based on queue depth to mitigate congestion and maintain efficient bandwidth allocation.

Using the revised algorithm, the PID controller further adjusts the CIRs based on the difference between the reference queue depth and the current queue depth, scaled by the queue depth adjustment coefficient Kq, which is a predefined parameter set prior to operation, similar to other PID controller parameters such as Kp, Ki, and Kd. The primary purpose of incorporating queue depth into the CIR adjustment is to address buffer bloat, preventing the queue from maintaining a persistently high depth, which could lead to increased network delay. Other objectives, such as achieving max-min or weighted fairness, are primarily managed by the proportional, integral, and derivative terms of the PID controller. When Kq is set to zero, it indicates that queue depth control is disabled, meaning CIR adjustments are not influenced by the queue state, for example, in scenarios where buffer bloat is not a concern or queue congestion is minimal. When Kq is set to a non-zero value, the PID controller uses the queue depth difference to dynamically adjust CIRs, maintaining the queue depth around the reference value. This mechanism prioritizes green packets, minimizes yellow packet transmission, and mitigates unfairness from their probabilistic discarding.

Note that, the CIR adjustment mechanism by the adjustment circuit 1020 uses a single shared CIR adjustment parameter Dynamic_Adj_CIR to manage all traffic control units TC_1 to TC_n. Those skilled in the art may implement the CIR adjustment in various ways as long as the CIR adjustment parameter Dynamic_Adj_CIR is considered for all the traffic control units TC_1 to TC_n. For example, in one implementation, all the traffic control units TC_1 to TC_n share the same CIR value, promoting uniform bandwidth allocation among the data flows DF_1 to DF_n. The CIR adjustment parameter Dynamic_Adj_CIR may directly specify the CIR value applied identically to each traffic control unit TC_i, or it may represent an adjustment magnitude added to the current CIR to compute a new uniform CIR. For example, if the PID controller determines a Dynamic_Adj_CIR value of 10 Mbps, in an embodiment, each traffic control unit TC_i sets its CIR to 10 Mbps; or, in another embodiment, each traffic control unit TC_i adjusts its CIR by 10 Mbps. Alternatively, in another embodiment, if all traffic control units TC_i start with the same initial CIR, each TC_i adjusts its CIR by adding 10 Mbps, resulting in identical CIR values across all traffic control units. In these cases, where all traffic control units TC_1 to TC_n apply the same CIR, all data flows DF_1 to DF_n are constrained to the same rate threshold, enabling the achievement of max-min fairness. However, if the initial CIR values of the traffic control units TC_i differ, adjusting each CIR by a uniform increment, such as 10 Mbps, results in different final CIR values, and thus the data flows may not operate at the same rate threshold. This uniform CIR approach simplifies configuration and is effective in scenarios where equal bandwidth sharing is desired.

In another embodiment, the traffic management apparatus 102 applies a weighted fairness mechanism, where the CIRs for the traffic control units TC_1 to TC_n may differ based on allocated weights for the data flows DF_1 to DF_n. The rate control circuit 1022 or an upper-layer controller may assign weights to each data flow DF_i, and the adjustment circuit 1020 uses the CIR adjustment parameter Dynamic_Adj_CIR as an adjustment magnitude to compute individual CIRs for each traffic control unit TC_i according to their respective weights. For instance, if the CIR adjustment parameter Dynamic_Adj_CIR represents an adjustment of 10 Mbps and the data flow DF_1 has a weight of 2 while the data flow DF_2 has a weight of 1, the adjustment circuit 1020 may increase the CIR of the traffic control unit TC_1 by 20 Mbps (2×10) and the CIR of the traffic control unit TC_2 by 10 Mbps (1×10), resulting in different CIRs that reflect proportional bandwidth allocation. The rate control circuit 1022 ensures these weighted CIRs are applied, enabling higher-weighted flows to receive greater bandwidth shares. This weighted fairness approach, tailored to network priorities or service-level agreements, allows flexible bandwidth distribution while maintaining coordinated control via the shared CIR adjustment parameter Dynamic_Adj_CIR.

The uniform CIR and weighted fairness embodiments demonstrate the versatility of the traffic management apparatus 102 in achieving fairness objectives using a single shared CIR adjustment parameter Dynamic_Adj_CIR. The uniform CIR approach ensures equitable bandwidth distribution for scenarios requiring max-min fairness, while the weighted fairness mechanism supports customized bandwidth allocation based on network priorities. Both embodiments leverage the PID precise adjustments to maintain rate alignment, enhancing efficiency and scalability.

In addition, as mentioned in the above, the network processing component 100 may be any functional or physical entity where the data flows DF_1 to DF_n converge as the output data flow DF_op, such as a queue. When the network processing component 100 is implemented as a queue, the network processing component 100 typically includes a buffer to temporarily store packets, enabling the adjustment circuit 1020 to monitor queue depth and adjust CIRs to manage congestion, as described above. However, the network processing component 100 is not limited to a queue and may be other network elements, such as a rate-limiting meter or a traffic shaper, which process the data flows DF_1 to DF_n to produce the output data flow DF_op. This flexibility allows the traffic management apparatus 102 to operate effectively in diverse network architectures.

For example, in configurations where the network processing component 100 is a second-level traffic control unit, such as a rate-limiting meter (e.g., per RFC 4115), limiting the total data rate of the output data flow DF_op, the adjustment circuit 1020 may adjust CIRs based solely on the ingress/egress rate difference, without queue depth monitoring. The egress rate, measured after the second-level traffic control unit, informs computation of the CIR adjustment parameter Dynamic_Adj_CIR, aligning the ingress rate with the rate limit efficiently.

The traffic management apparatus 102, with the adjustment circuit 1020 and the rate control circuit 1022, outperforms traditional bandwidth management techniques, such as static metering (e.g., trTCM per RFC 2698) and complex queuing (e.g., Weighted Fair Queuing, WFQ). By dynamically adjusting CIRs using a shared CIR adjustment parameter Dynamic_Adj_CIR, the traffic management apparatus 102 aligns the ingress rate, comprising green packets, with the egress rate, particularly under load conditions indicated by the queue busy status. This minimizes yellow packet transmission, mitigates unfairness from probabilistic discarding, and achieves max-min or weighted fairness without per-flow queuing.

The configuration of the traffic management apparatus 102 with the adjustment circuit 1020 and the rate control circuit 1022 represents one embodiment of the present invention. Alternative implementations may combine these functions into a single circuit, distribute them across multiple components, or integrate them with other network management modules, provided the core functionality of dynamic CIR adjustment using the CIR adjustment parameter Dynamic_Adj_CIR is maintained. This adaptability enables the traffic management apparatus 102 to be deployed in various forms, ensuring compatibility with diverse network environments. For example, the traffic management apparatus 102 may be implemented as an application-specific integrated circuit (ASIC) or field-programmable gate array (FPGA) within a router, a software module on a general-purpose processor, or a cloud-based controller, ensuring flexibility across network architectures. The data transmission system 10, with the traffic management apparatus 102 at its core, addresses the critical need for adaptive bandwidth management in dynamic network environments, providing a robust platform for fair bandwidth allocation.

Therefore, the data transmission system 10, through use of the traffic management apparatus 102, achieves robust and adaptive bandwidth management, as evidenced by its ability to dynamically align ingress and egress rates using the shared CIR adjustment parameter Dynamic_Adj_CIR. Key advantages include improved fairness, reduced network delay, and enhanced scalability compared to traditional metering and queuing techniques. These benefits can be validated through a series of simulation results, described below, which demonstrate the system performance under various network conditions and traffic types.

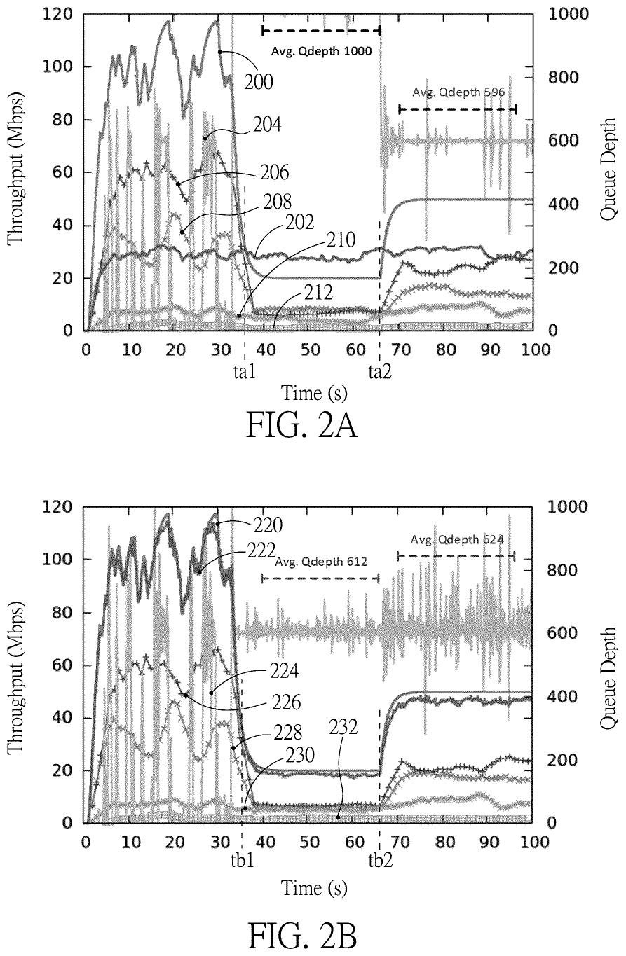

Please refer to FIG. 2A and FIG. 2B, which are schematic diagrams of simulation results for a traditional fixed CIR system and the data transmission system 10, respectively, in terms of max-min fairness for User Datagram Protocol (UDP) traffic. Both experimental setups involve four UDP flows (i.e. n=4) with rates of 64 Mbps, 32 Mbps, 8 Mbps, and 2 Mbps, modeled using a Poisson Pareto Burst Process (PPBP) to simulate real-world network traffic fluctuations. The egress bandwidth dynamically varies between 120 Mbps, 20 Mbps, and 50 Mbps. Both the traditional fixed CIR system and the data transmission system 10 equip queues (i.e. the network processing component 100 is implemented as a queue), which is configured as a Random Early Detection (RED) queue with a buffer size of 1000 packets, a minimum threshold of 300 packets, and a maximum threshold of 600 packets. The maximum threshold is designated as the reference queue depth.

FIG. 2A depicts the performance of the traditional fixed CIR system (set at 10 Mbps for each UDP flow), where a curve 200 represents the egress rate of the output data flow, a curve 202 represents the ingress rate of green packets (i.e. green rate), a curve 204 represents the queue depth, and curves 206-212 represent UDP flows with rates of 64 Mbps, 32 Mbps, 8 Mbps, and 2 Mbps. As can be seen from FIG. 2A, at a time point ta1, the egress bandwidth drops to 20 Mbps from 120 Mbps, the total green packet rate (30 Mbps) exceeds the egress rate, causing the queue to rapidly reach its maximum capacity of 1000 packets. This congestion results in packet loss, even for the 2 Mbps flow, which theoretically should pass entirely, leading to unfair bandwidth allocation (e.g., 6.7 Mbps, 8.1 Mbps, 4.1 Mbps, 1.1 Mbps versus the target 6 Mbps, 6 Mbps, 6 Mbps, 2 Mbps). When the egress bandwidth increases to 50 Mbps from 20 Mbps at a time point ta2, the queue depth stabilizes below 1000 packets due to probabilistic discarding of yellow packets, but this randomness causes unfairness, as flows with more yellow packets (e.g., the 64 Mbps flow with 54 Mbps yellow packets) gain disproportionate bandwidth (e.g., 24.3 Mbps for 64 Mbps flow vs. 15 Mbps for 32 Mbps flow), failing to achieve max-min fairness.

In contrast, FIG. 2B illustrates the performance of the data transmission system 10, where a curve 220 represents the egress rate of the output data flow, a curve 222 represents the ingress rate of green packets (i.e., green rate), a curve 224 represents the queue depth, and curves 226-232 represent UDP flows with rates of 64 Mbps, 32 Mbps, 8 Mbps, and 2 Mbps. The core objective of the data transmission system 10 is to ensure that the green rate closely tracks the egress rate of the output data flow DF_op, to minimize yellow packet transmission during congestion. As can be seen from FIG. 2B, even though the egress bandwidth drops to 20 Mbps from 120 Mbps and increases to 50 Mbps from 20 Mbps between time points tb1 and tb2, the green rate still follows the egress rate. In other words, regardless of whether the egress bandwidth is 20 Mbps or 50 Mbps, the adjustment circuit 1020 dynamically adjusts the CIRs for the UDP flows, enabling the green rate to closely follow the egress rate. Additionally, the data transmission system 10 maintains the queue depth near the reference value of 600 packets, so as to reduce delay. The resulting bandwidth allocation (e.g., close to the target 6 Mbps, 6 Mbps, 6 Mbps, 2 Mbps at 20 Mbps) approaches theoretical max-min fairness, and demonstrates significant improvements over the fixed CIR approach.

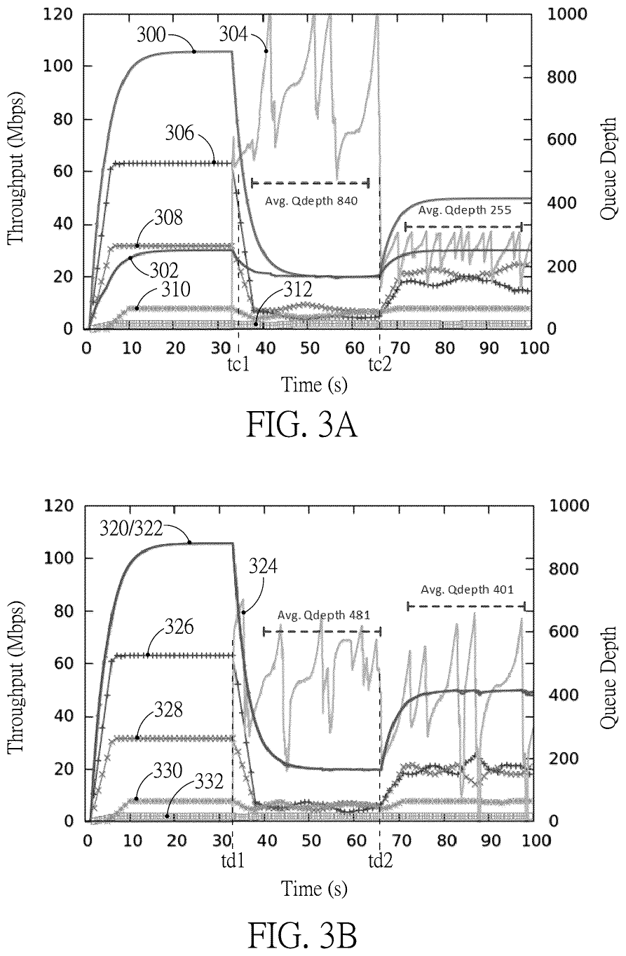

Please refer to FIG. 3A and FIG. 3B, which are schematic diagrams of simulation results for a traditional fixed CIR system and the data transmission system 10, respectively, in terms of max-min fairness for Transmission Control Protocol (TCP) traffic. Both experimental setups involve four TCP flows with rates of 64 Mbps, 32 Mbps, 8 Mbps, and 2 Mbps, modeled as bulk traffic (continuous sending) to simulate sustained data transfer. The egress bandwidth dynamically varies between 120 Mbps, 20 Mbps, and 50 Mbps. Both the traditional fixed CIR system and the data transmission system 10 equip queues (i.e. the network processing component 100 is implemented as a queue), which is configured as a RED queue with a buffer size of 1000 packets, a minimum threshold of 300 packets, and a maximum threshold of 600 packets. The maximum threshold is designated as the reference queue depth.

FIG. 3A depicts the performance of the traditional fixed

CIR system (set at 10 Mbps for each TCP flow), where a curve 300 represents the egress rate of the output data flow, a curve 302 represents the ingress rate of green packets (i.e., green rate), a curve 304 represents the queue depth, and curves 306-312 represent TCP flows with rates of 64 Mbps, 32 Mbps, 8 Mbps, and 2 Mbps. As can be seen from FIG. 3A, at a time point tc1, the egress bandwidth drops to 20 Mbps from 120 Mbps, and TCP congestion control reduces sending rates to avoid packet loss, aligning the egress rate with 20 Mbps. However, since most packets are green due to TCP rate reduction, the probabilistic discarding mechanism for RED queue becomes ineffective, causing the queue depth to reach 1000 packets. This results in unfair bandwidth allocation (e.g., 4.7 Mbps, 7.8 Mbps, 5.3 Mbps, 1.9 Mbps versus the target 6 Mbps, 6 Mbps, 6 Mbps, 2 Mbps). Even the lowest-rate flow (i.e., 2 Mbps TCP flow) suffers packet loss. At a time point tc2, when the egress bandwidth increases to 50 Mbps from 20 Mbps, TCP congestion control and RED discarding combine effectively, achieving fairness and stabilizing queue depth.

In contrast, FIG. 3B illustrates the performance of the data transmission system 10, where a curve 320 represents the egress rate of the output data flow, a curve 322 represents the ingress rate of green packets (i.e., green rate), a curve 324 represents the queue depth, and curves 326-332 represent TCP flows with rates of 64 Mbps, 32 Mbps, 8 Mbps, and 2 Mbps. The core objective of the data transmission system 10 is to ensure that the green rate closely tracks the egress rate of the output data flow DF_op, minimizing yellow packet transmission during congestion. As can be seen from FIG. 3B, even though the egress bandwidth drops to 20 Mbps from 120 Mbps at time point td1 and increases to 50 Mbps from 20 Mbps at time point td2, the green rate is able to closely follow these changes in the egress rate. In other words, regardless of whether the egress bandwidth is 20 Mbps or 50 Mbps, the adjustment circuit 1020 dynamically adjusts the CIRs for the TCP flows, enabling the green rate to track the egress rate effectively. Additionally, the data transmission system 10 maintains the queue depth within an ideal range (e.g., around 481 or 401 packets), to reduce delay. The resulting bandwidth allocation approaches theoretical max-min fairness, and demonstrates significant improvements over the fixed CIR approach by mitigating TCP's coordination issues. Specifically, the TCP coordination issues refer to the inherent limitations of TCP's congestion control mechanism, which automatically adjusts sending rates to avoid packet loss but does not inherently ensure max-min fairness. As observed in the traditional fixed CIR system at 20 Mbps egress bandwidth, TCP congestion control results in unfair bandwidth allocation (e.g., 4.7 Mbps, 7.8 Mbps, 5.3 Mbps, 1.9 Mbps versus the target 6 Mbps, 6 Mbps, 6 Mbps, 2 Mbps), as its mechanism is not designed to achieve equitable bandwidth sharing. The data transmission system 10 addresses this by dynamically adjusting CIRs to enforce fair allocation, ensuring that the bandwidth distribution closely aligns with max-min fairness objectives.

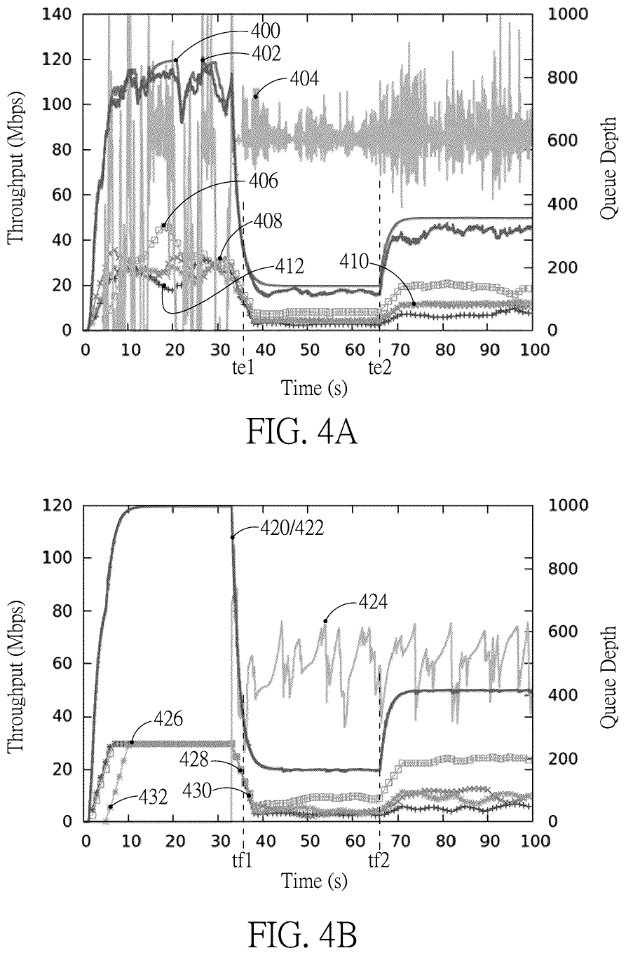

Please refer to FIG. 4A and FIG. 4B, which are schematic diagrams of simulation results for the data transmission system 10, respectively, in terms of weighted fairness for both UDP and TCP traffics. The experimental setup involves four UDP or TCP flows at 30 Mbps each, with weights assigned in the ratio 1:2:2:4 to achieve proportional bandwidth allocation using the CIR adjustment parameter Dynamic_Adj_CIR. The egress bandwidth dynamically varies between 120 Mbps, 20 Mbps, and 50 Mbps. The network processing component 100 is implemented as a RED queue with a buffer size of 1000 packets, a minimum threshold of 300 packets, and a maximum threshold of 600 packets. The maximum threshold is designated as the reference queue depth.

FIG. 4A depicts the performance for UDP traffic, where a curve 400 represents the egress rate of the output data flow, a curve 402 represents the ingress rate of green packets (i.e., green rate), a curve 404 represents the queue depth, and curves 406-412 represent UDP flows. As can be seen from FIG. 4A, at a time point te1, the egress bandwidth drops to 20 Mbps, and the adjustment circuit 1020 dynamically adjusts the CIRs based on the weights 1, 2, 2, and 4 under weighted fairness objective, allocating bandwidth proportionally. The resulting allocation (e.g., 2.9 Mbps, 4.5 Mbps, 4.4 Mbps, 8.5 Mbps vs. target 2.2 Mbps, 4.4 Mbps, 4.4 Mbps, 8.9 Mbps) closely matches the desired ratio, with the green rate tracking the egress rate. At a time point te2, when the egress bandwidth increases to 50 Mbps from 20 Mbps, the proportional allocation remains accurate (e.g., 7.0 Mbps, 11.3 Mbps, 11.8 Mbps, 19.5 Mbps vs. target 5.6 Mbps, 11.1 Mbps, 11.1 Mbps, 22.2 Mbps), and the queue depth stabilizes around 600 packets.

FIG. 4B illustrates the performance for TCP traffic, where a curve 420 represents the egress rate of the output data flow, a curve 422 represents the ingress rate of green packets (i.e., green rate), a curve 424 represents the queue depth, and curves 426-432 represent TCP flows. Similar to UDP, the data transmission system 10 maintains proportional bandwidth allocation across time points tf1 and tf2 (20 Mbps and 50 Mbps), with allocations closely approaching a target ratio. The green rate follows the egress rate, and the queue depth remains near 600 packets, demonstrating the ability to achieve weighted fairness while ensuring stability and effective queue control for both traffic types.

FIGS. 2A to 4B illustrate that the data transmission system 10 overcomes the limitations of traditional metering schemes in dynamic network environments, where the network processing component 100 is implemented as a queue. The similar results may be seen if the network processing component 100 is a second-level meter (e.g., per RFC 4115) with rate-limiting functionality.

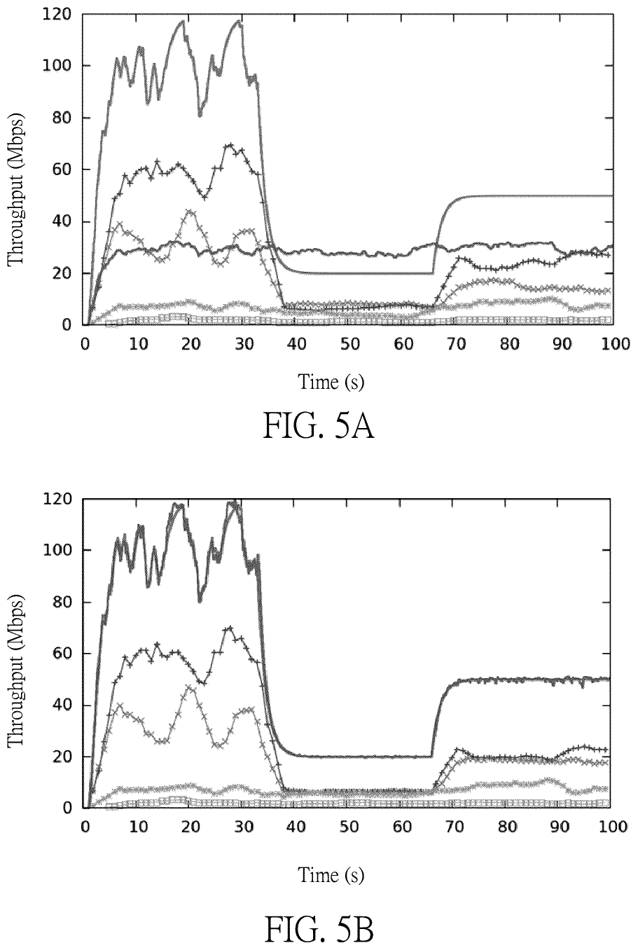

Please refer to FIG. 5A and FIG. 5B, which are schematic diagrams of simulation results for a traditional fixed CIR system and the data transmission system 10, respectively, in terms of max-min fairness for UDP traffic. The experimental setups for FIG. 5A and FIG. 5B are similar to those for FIG. 2A and FIG. 2B, except that both the traditional fixed CIR system and the data transmission system 10 do not equip queues, i.e. the network processing component 100 is a second-level meter with rate-limiting functionality. Similar to FIG. 2A, FIG. 5A depicts the traditional fixed CIR system, where the probabilistic discarding of yellow packets during congestion (e.g., at 20 Mbps egress bandwidth) leads to unfair bandwidth allocation, as flows with more yellow packets gain disproportionate shares, failing to achieve max-min fairness. In contrast, FIG. 5B, like FIG. 2B, shows performance of the data transmission system 10, where the adjustment circuit 1020 dynamically adjusts the CIRs using the CIR adjustment parameter Dynamic_Adj_CIR, ensuring the green rate closely tracks the egress rate of the output data flow DF_op. This alignment minimizes yellow packet transmission, achieves fair bandwidth allocation across the UDP flows, and demonstrates the system's adaptability even without queue buffering.

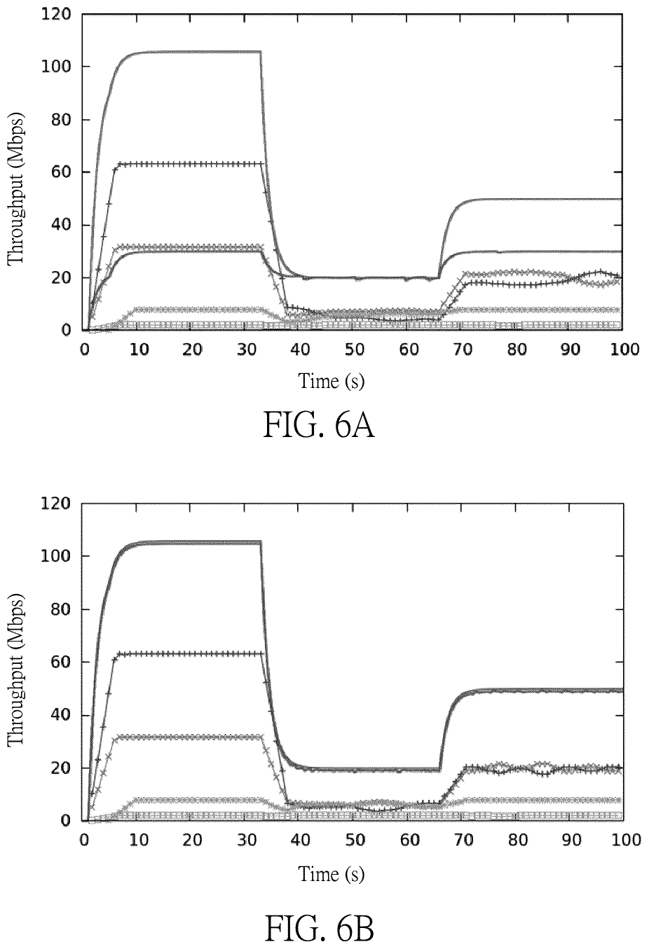

Please refer to FIG. 6A and FIG. 6B, which are schematic diagrams of simulation results for a traditional fixed CIR system and the data transmission system 10, respectively, in terms of max-min fairness for TCP traffic. The experimental setups for FIG. 6A and FIG. 6B are similar to those for FIG. 3A and FIG. 3B, except that both the traditional fixed CIR system and the data transmission system 10 do not equip queues, i.e. the network processing component 100 is a second-level meter with rate-limiting functionality. Similar to FIG. 3A, FIG. 6A illustrates that TCP congestion control in the traditional fixed CIR system reduces rates at low egress bandwidth (e.g., 20 Mbps), but the predominance of green packets renders RED discarding ineffective, leading to uncontrolled queue depth and unfair bandwidth allocation. In contrast, FIG. 6B, like FIG. 3B, shows performance of the data transmission system 10, where the adjustment circuit 1020 dynamically adjusts CIRs using the CIR adjustment parameter Dynamic_Adj_CIR, enabling the green rate to track the egress rate of the output data flow DF_op. This ensures fair bandwidth allocation for TCP flows, with manageable queue depth fluctuations, highlighting the system robustness without queue depth control.

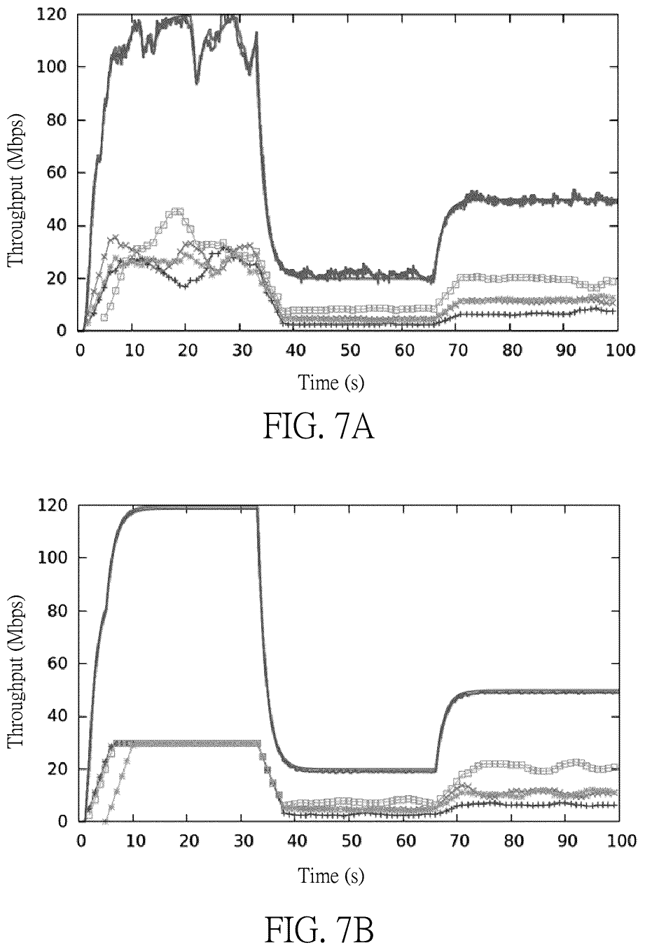

Please refer to FIG. 7A and FIG. 7B, which are schematic diagrams of simulation results for the data transmission system 10, respectively, in terms of weighted fairness for both UDP and TCP traffics. The experimental setups for FIG. 7A and FIG. 7B are similar to those for FIG. 4A and FIG. 4B, except that the data transmission system 10 does not equip queues, i.e. the network processing component 100 is a second-level meter with rate-limiting functionality. Similar to FIG. 4A and FIG. 4B, FIG. 7A and FIG. 7B show that bandwidth allocations close to the target weighted ratio for both UDP and TCP flows, demonstrating the system effectiveness in weighted fairness scenarios without queue depth control.

Note that, FIG. 2A to FIG. 7B collectively present a series of simulation results that systematically demonstrate how the data transmission system 10 overcomes the limitations of traditional metering schemes in dynamic network environments. The data transmission system 10 uses the traffic management apparatus 102 to dynamically adjust the shared CIR adjustment parameter Dynamic_Adj_CIR across all traffic control units TC_1 to TC_n, ensuring the ingress rate of green packets closely tracks the egress rate of the output data flow DF_op. As shown in FIG. 2A to FIG. 3B, the embodiment of the present invention mitigates unfairness from probabilistic yellow packet discarding in UDP and TCP traffic, to achieve max-min fairness. FIG. 4A and FIG. 4B highlight the system ability to support weighted fairness, while FIG. 5A and FIG. 5B demonstrate its applicability in queue-less configurations. FIG. 6A to FIG. 7B further validate the robustness of the CIR adjustment parameter Dynamic_Adj_CIR without queue depth control, maintaining fairness with minimal queue depth fluctuations. The experimental results confirm that the data transmission system 10 outperforms traditional methods in achieving max-min and weighted fairness, with superior adaptability to UDP and TCP traffic, effective queue depth control, and reduced delay, showcasing its flexibility and scalability across diverse network scenarios.

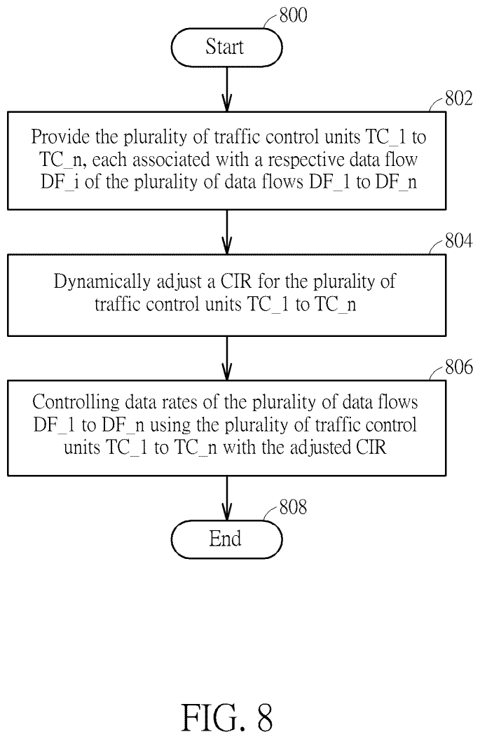

The operations of the data transmission system 10 described above can be summarized into a process 80, as shown in FIG. 8. The process 80 includes the following steps:
Step 800: Start.
Step 802: Provide the plurality of traffic control units TC_1 to TC_n, each associated with a respective data flow DF_i of the plurality of data flows DF_1 to DF_n.
Step 804: Dynamically adjust a CIR for the plurality of traffic control units TC_1 to TC_n.
Step 806: Controlling data rates of the plurality of data flows DF_1 to DF_n using the plurality of traffic control units TC_1 to TC_n with the adjusted CIR.
Step 808: End.

The detailed operations of the process 80 can be referred to the foregoing description and are not repeated here.

The prior art bandwidth management techniques often struggle to achieve fair and efficient bandwidth utilization in dynamic network environments where traffic loads and available bandwidth fluctuate unpredictably. In comparison, the present invention significantly overcomes these shortcomings by dynamically adjusting CIR for multiple traffic control units. This dynamic adjustment is meticulously performed based on the real-time difference between the ingress rate and the egress rate at a network processing component, to ensure that the total rate of compliant incoming data closely matches the system egress capacity, thereby maximizing bandwidth utilization and minimizing packet loss due to congestion.

In summary, the present invention provides an innovative solution for managing data flows in dynamic network environments, and reaching max-min or weighted fairness without the complexity of per-flow queuing.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for managing a plurality of data flows associated with a network processing component in a data transmission system, the method comprising:
providing a plurality of traffic control units, each associated with a respective data flow of the plurality of data flows;
dynamically adjusting a committed information rate (CIR) for the plurality of traffic control units; and
controlling data rates of the plurality of data flows using the plurality of traffic control units with the adjusted CIR.

2. The method of claim 1, wherein dynamically adjusting the CIR is based on at least one of an ingress rate or an egress rate at the network processing component.

3. The method of claim 2, wherein dynamically adjusting the CIR is based on a difference between the ingress rate and the egress rate at the network processing component.

4. The method of claim 3, wherein dynamically adjusting the CIR comprises using a proportional-integral-derivative (PID) controller to compute an adjustment for the CIR based on the difference between the ingress rate and the egress rate.

5. The method of claim 4, wherein the PID controller further incorporates a constant value to influence a direction of change of the CIR when the ingress rate equals the egress rate.

6. The method of claim 2, wherein each of the traffic control units marks data packets of the respective data flow as compliant when a data rate of the data packets is less than the CIR, and the ingress rate is a total data rate of data packets marked as compliant by the plurality of traffic control units and input to the network processing component from the plurality of data flows.

7. The method of claim 1, wherein dynamically adjusting the CIR is performed periodically at a predetermined time interval.

8. The method of claim 1, wherein the network processing component comprises a buffer, and the method further comprises:
monitoring a queue depth of the buffer in the network processing component; and
further adjusting the CIR based on the queue depth.

9. The method of claim 8, wherein further adjusting the CIR based on the queue depth is performed when the queue depth exceeds a reference value.

10. The method of claim 1, further comprising:
applying a weighted fairness mechanism by allocating different weights to the plurality of data flows, wherein the CIR for each of the plurality of traffic control units is adjusted according to the weights to achieve a proportional allocation of bandwidth.

11. A traffic management apparatus for managing a plurality of data flows associated with a network processing component in a data transmission system, the traffic management apparatus comprising:
an adjustment circuit that dynamically adjusts a committed information rate (CIR) for a plurality of traffic control units, wherein each of the plurality of traffic control units is associated with a respective data flow of the plurality of data flows; and
a rate control circuit that controls data rates of the plurality of data flows using the plurality of traffic control units with the adjusted CIR.

12. The traffic management apparatus of claim 11, wherein the adjustment circuit dynamically adjusts the CIR based on at least one of an ingress rate or an egress rate at the network processing component.

13. The traffic management apparatus of claim 12, wherein the adjustment circuit dynamically adjusts the CIR based on a difference between the ingress rate and the egress rate at the network processing component.

14. The traffic management apparatus of claim 13, wherein the adjustment circuit uses a proportional-integral-derivative (PID) controller to determine an adjustment for the CIR based on the difference between the ingress rate and the egress rate.

15. The traffic management apparatus of claim 14, wherein the PID controller further incorporates a constant value to influence a direction of change of the CIR when the ingress rate equals the egress rate.

16. The traffic management apparatus of claim 12, wherein each of the traffic control units marks data packets of the respective data flow as compliant when a data rate of the data packets is less than the CIR, and the ingress rate is a total data rate of data packets marked as compliant by the plurality of traffic control units and input to the network processing component from the plurality of data flows.

17. The traffic management apparatus of claim 11, wherein the adjustment circuit dynamically adjusts the CIR periodically at a predetermined time interval.

18. The traffic management apparatus of claim 11, wherein the network processing component comprises a buffer, wherein the adjustment circuit monitors a queue depth of the buffer in the network processing component, and further adjusts the CIR based on the queue depth.

19. The traffic management apparatus of claim 18, wherein the adjustment circuit adjusts the CIR based on the queue depth when the queue depth exceeds a reference value.

20. The traffic management apparatus of claim 11, wherein the rate control circuit further applies a weighted fairness mechanism by allocating different weights to the plurality of data flows, wherein the CIR for each of the plurality of traffic control units is adjusted according to the weights to achieve a proportional allocation of bandwidth.
